(19) United States
(12) Patent Application Publication
(10) Pub. No.: US 2021/0122934 A1
(43) Pub. Date: Apr. 29, 2021

(54) LIQUID ELECTROPHOTOGRAPHIC INK COMPOSITION

(71) Applicant: Hewlett-Packard Development Company, L.P., Spring, TX (US)

(72) Inventors: Guy Nesher, Nes Ziona (IL); Julia Kornilov, Nes Ziona (IL); Gil Bar-Haim, Nes Ziona (IL); Yaron Grinwald, Nes Ziona (IL); Keren Goldshtein, Nes Ziona (IL); Itay Eyal, Nes Ziona (IL)

(21) Appl. No.: 17/051,038

(22) PCT Filed: Nov. 29, 2018
(86) PCT No.: PCT/US2018/063158

§ 371 Date: Oct. 27, 2020

(51) Int. Cl. C09D 11/08; G03G 9/125; G03G 9/135; G03G 9/08; C09D 11/037

(52) U.S. Cl. CPC C09D 11/08; G03G 9/125; C09D 11/037; G03G 9/0804; G03G 9/135

(57) ABSTRACT

Herein are describes liquid electrophotographic ink compositions and methods for producing liquid electrophotographic ink composition. The liquid electrophotographic ink compositions may be producing using a method comprising: grinding a resin and a pigment to form a paste; reacting an aluminium C₁₂₋₂₄ carboxylate and a molecule having a molecular weight (Mw) of less than about 1000 and comprising a functional group selected from an amide, an ester, a carboxylic acid, an amine, an imide and combinations thereof to form a charge promoting component; and combining the paste and the charge promoting component to form a liquid electrophotographic ink.

### BACKGROUND

Liquid electrophotographic printing processes, sometimes termed liquid electrostatic printing processes, typically involve creating an image on a photoconductive surface, applying an ink having charged particles to the photoconductive surface, such that they selectively bind to the image, and then transferring the charged particles in the form of the image to a print substrate.

The photoconductive surface may be on a cylinder and is often termed a photo imaging plate (PIP). The photoconductive surface is selectively charged with a latent electrostatic image having image and background areas with different potentials. For example, an electrophotographic ink composition including charged toner particles in a liquid carrier can be brought into contact with the selectively charged photoconductive surface. The charged toner particles adhere to the image areas of the latent image while the background areas remain clean. The image is then transferred to a print substrate (e.g. paper) directly or, by being first transferred to an intermediate transfer member, which can be a soft swelling blanket, which is often heated to fuse the solid image and evaporate the liquid carrier, and then to the print substrate.

### BRIEF DESCRIPTION OF THE FIGURE

FIG. 1 is a schematic illustration of an example of a liquid electrophotographic (LEP) printing apparatus for printing an LEP ink composition.

### DETAILED DESCRIPTION

Before the methods and related aspects of the disclosure are disclosed and described, it is to be understood that this disclosure is not restricted to the particular method features and materials disclosed herein because such method features and materials may vary somewhat. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “liquid carrier”, “carrier liquid”, “carrier,” or “carrier vehicle” refers to the fluid in which the polymer resin, pigment, charge directors and/or other additives can be dispersed to form a liquid electrostatic ink or electrophotographic ink. Liquid carriers can include a mixture of a variety of different agents, such as surfactants, co-solvents, viscosity modifiers, and/or other possible ingredients.

As used herein, “electrophotographic ink composition”, sometimes referred to as an “electrostatic ink composition”, generally refers to an ink composition, which may be in liquid form, generally suitable for use in an electrophotographic printing process, sometimes termed an electrostatic printing process. The electrophotographic ink composition may include chargeable particles of the resin and the pigment dispersed in a liquid carrier and a charge promoting component, which may be as described herein.

As used herein, “co-polymer” refers to a polymer that is polymerized from at least two monomers.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, “melt flow rate” is measured per ASTM D1238-04c Standard Test Method for Melt Flow Rates of Thermoplastics by Extrusion Plastometer. If a melt flow rate of a particular polymer is specified, unless otherwise stated, it is the melt flow rate for that polymer alone, in the absence of any of the other components of the electrostatic composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa-s or cPoise. In some examples, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate. If the melt viscosity of a particular polymer is specified, unless otherwise stated, it is the melt viscosity for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic(ally) printing” or “electrophotographic(ally) printing” generally refers to the process that provides an image that is transferred from a photo imaging substrate or plate either directly or indirectly via an intermediate transfer member to a print substrate, e.g. a paper substrate. As such, the image is not substantially absorbed into the photo imaging substrate or plate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrophotographic ink composition to an electric field, e.g. an electric field having a field strength of 1000 V/cm or more, in some examples 1000 V/mm or more.

As used herein, the term “about” is used to provide flexibility to a numerical range endpoint by providing that a given value may be a little above or a little below the endpoint. The degree of flexibility of this term can be dictated by the particular variable.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless specified otherwise, wt % values are to be taken as referring to a weight-for-weight (w/w) percentage of solids in the ink composition, and not including the weight of any carrier fluid present. As used herein, unless specified otherwise, the solids include any compound or mixture forming part of the LEP ink composition that remains on a print substrate after printing of the LEP ink composition, whether or not the compound or mixture is a liquid or a solid when initially combined with the other components of the LEP ink composition.

As used herein, the term “Mw” is used to refer to a weight averaged molecular weight.

Unless otherwise stated, any feature described herein can be combined with any aspect or any other feature described herein.

Previous attempts at significantly increasing the amount of pigment contained in liquid electrophotographic ink compositions have encountered problems in relation to the charging of the inks. The present inventors have surprisingly found that the methods and compositions described herein allow liquid electrophotographic ink compositions having improved pigment loading to be successfully provided. The present inventors have also found that the methods and compositions described herein provide further advantages in relation to the efficiency of producing liquid electrophotographic ink compositions.

In an aspect, the present invention provides a method for producing a liquid electrophotographic ink composition. The method may comprise:

grinding a resin and a pigment to form a paste;

reacting an aluminium C₁₂₋₂₄ carboxylate and a molecule having a molecular weight (Mw) of less than 1000 and comprising a functional group selected from an amide, an ester, a carboxylic acid, an amine, an imide and combinations thereof to form a charge promoting component; and

combining the paste and the charge promoting component to form a liquid electrophotographic ink.

In an aspect, the present invention provides a liquid electrophotographic ink composition. The liquid electrophotographic ink composition may comprise:

at least about 40 wt. % of a pigment by total solids of the composition;

from about 10 wt. % to about 55 wt. % of a resin by total solids of the composition;

from about 2 wt. % to about 20 wt. % of an aluminium C₁₂₋₂₄ carboxylate by total solids of the composition; and

from about 0.1 wt. % to about 10 wt. % by total solids of the composition of a molecule having a molecular weight (Mw) of less than 1000 and comprising a functional group selected from an amide, an ester, a carboxylic acid, an amine, an imide and combinations thereof.

In an aspect, the present invention provides a method of printing a liquid electrophotographic ink composition. The method may comprise:

providing a liquid electrophotographic ink composition; and

liquid electrostatically printing the liquid electrostatic ink composition onto a substrate,

wherein the liquid electrophotographic ink composition comprises:
at least about 40 wt. % of a pigment by total solids of the composition;
from about 10 wt. % to about 55 wt. % of a resin by total solids of the composition; and
from about 2 wt. % to about 20 wt. % of an aluminium C₁₂₋₂₄ carboxylate by total solids of the composition; and
from about 0.1 wt. % to about 10 wt. % by total solids of the composition of a molecule having a molecular weight (Mw) of less than 1000 and comprising a functional group selected from an amide, an ester, a carboxylic acid, an amine, an imide and combinations thereof.

In some examples, the liquid electrophotographic ink composition comprises:

at least about 40 wt. % of a pigment by total solids of the composition;

up to about 40 wt. % of a resin by total solids of the composition;

from about 2 wt. % to about 15 wt. % of an aluminium C₁₂₋₂₄ carboxylate by total solids of the composition; and

from about 0.5 wt. % to about 5 wt. % by total solids of the composition of a molecule having a molecular weight (Mw) of less than 1000 and comprising a functional group selected from an amide, an ester, a carboxylic acid, an amine, an imide and combinations thereof.

### Liquid Electrostatic Ink Composition

The liquid electrophotographic ink compositions (or LEP ink compositions) referred to herein may comprise a pigment, a resin and a charge promoting component. The charge promoting component may be formed by combining an aluminium C₁₂₋₂₄ carboxylate and a molecule having a molecular weight (Mw) of less than 1000 and comprising a functional group selected from an amide, an ester, a carboxylic acid, an amine, an imide and combinations thereof

### Resin

In some examples, the LEP ink composition includes chargeable particles comprising a resin. The resin may be a thermoplastic resin. A thermoplastic polymer is sometimes referred to as a thermoplastic resin. The resin may coat a colourant/pigment. In some examples, the resin coats a pigment/colorant such that particles are formed having a core of pigment/colourant and an outer layer of resin thereon. The outer layer of resin may coat the pigment/colourant partially or completely.

In some examples, the electrostatic ink composition may comprise ink particles comprising a pigment and a resin.

In some examples, the resin may be selected from ethylene acid copolymers, ethylene acrylic acid copolymers; ethylene methacrylic acid copolymers; ethylene vinyl acetate copolymers; copolymers of ethylene (e.g. 80 wt % to 99.9 wt %), acrylic or methacrylic acid (40 to 0.1%)/alkyl (e.g. C1 to C5) ester of methacrylic or acrylic acid (e.g. 0.1 wt % to 20 wt %); copolymers of ethylene (e.g. 80 wt % to 99.9 wt %), acrylic or methacrylic acid (e.g. 0.1 wt % to 20.0 wt %) and alkyl (e.g. C1 to C5) ester of methacrylic or acrylic acid (e.g. 0.1 wt % to 20 wt %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt % to 90 wt %)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

In some examples, the resin is an ethylene acid copolymer, for example an ethylene acrylic acid copolymer, an ethylene methacrylic acid copolymer or combinations thereof. In some examples, the resin is a copolymer of an alkylene monomer and a monomer having an acid side group. In some examples the alkylene monomer is an ethylene or a propylene monomer. In some examples, the monomer having an acid side group is an acrylic acid monomer or a methacrylic acid monomer. In some examples, the electrostatic ink composition comprises a polymer resin comprising a copolymer of an alkylene monomer and a monomer selected from acrylic acid and methacrylic acid.

The resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures, for example using the procedure described in ASTM D1386.

The resin may comprise a polymer, in some examples a polymer having acidic side groups, that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes.

In some examples, the polymer having acid side groups has a melt flow rate of greater than about 120 g/10 minutes, in some examples greater than about 200 g/10 minutes, in some examples greater than about 300 g/10 minutes, in some examples greater than about 400 g/10 minutes. In some examples, the polymer having acid side groups has a melt flow rate of about 450 g/10 minutes.

In some examples, the polymer having acid side groups has a melt flow rate of less than about 500 g/10 minutes.

In some examples, the polymer having acid side groups has a melt flow rate in the range of about 150 g/10 minutes to about 600 g/10 minutes. In some examples, the polymer having acid side groups has a melt flow rate in the range of about 200 g/10 minutes to about 500 g/10 minutes.

In some examples, the polymer having acid side groups constitutes at least 50 wt. % of the resin, in some examples at least 60 wt. % in some examples at least 80 wt. %, in some examples at least 90 wt. %. In some examples, the polymer having acid side groups has a melt flow rate of greater than about 200 g/10 minutes, in some examples a melt flow rate of greater than about 200 g/10 minutes and up to about 500 g/10 minutes, and constitutes at least 50 wt. % of the resin, in some examples at least 60 wt. % in some examples at least 80 wt. %, in some examples at least 90 wt. %.

The melt flow rate can be measured using standard procedures, for example as described in ASTM D1238.

The acidic side groups may be in free acid form or may be in the form of an anion and associated with one or more counterions, generally metal counterions, e.g. a metal selected from the alkali metals, such as lithium, sodium and potassium, alkali earth metals, such as magnesium or calcium, and transition metals, such as zinc. The polymer having acidic sides groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt % to about 25 wt % of the copolymer, in some examples from 10 wt % to about 20 wt % of the copolymer.

The resin may comprise two different polymers having acidic side groups. The two polymers having acidic side groups may have different acidities, which may fall within the ranges mentioned above. The resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise two different polymers having acidic side groups: a first polymer that is a copolymer of ethylene (e.g. 92 to 85 wt %, in some examples about 89 wt %) and acrylic or methacrylic acid (e.g. 8 to 15 wt %, in some examples about 11 wt %) having a melt flow rate of 80 to 110 g/10 minutes and a second polymer that is a co-polymer of ethylene (e.g. about 80 to 92 wt %, in some examples about 85 wt %) and acrylic acid (e.g. about 18 to 12 wt %, in some examples about 15 wt %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

If the resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN ionomers. The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt % to about 16 wt % of the copolymer, in some examples 10 wt % to 16 wt % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt % to about 30 wt % of the copolymer, in some examples from 14 wt % to about 20 wt % of the copolymer, in some examples from 16 wt % to about 20 wt % of the copolymer in some examples from 17 wt % to 19 wt % of the copolymer.

In some examples, the resin essentially consists of a copolymer of ethylene and methacrylic acid. In some examples the methacrylic acid of the copolymer of ethylene and methacrylic acid constitutes about 8 wt % to about 12 wt % of the copolymer, in some examples about 9 wt % to about 11 wt % of the copolymer, in some examples about 10 wt. % of the copolymer.

In an example, the resin constitutes about 5 to 90%, in some examples about 5 to 80%, by weight of the solids of the electrostatic ink composition. In another example, the resin constitutes about 10 to 60% by weight of the solids of the electrostatic ink composition. In another example, the resin constitutes about 15 to 40% by weight of the solids of the electrostatic ink composition. In another example, the resin constitutes about 60 to 95% by weight, in some examples from 80 to 90% by weight, of the solids of the electrostatic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, for example, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the co-polymer, in some examples 5 to 40% by weight, in some examples 5 to 20% by weight of the copolymer, in some examples 5 to 15% by weight of the copolymer. The second monomer may constitute 1 to 50% by weight of the co-polymer, in some examples 5 to 40% by weight of the co-polymer, in some examples 5 to 20% by weight of the co-polymer, in some examples 5 to 15% by weight of the copolymer. In an example, the first monomer constitutes 5 to 40% by weight of the co-polymer, the second monomer constitutes 5 to 40% by weight of the co-polymer, and with the third monomer constituting the remaining weight of the copolymer. In an example, the first monomer constitutes 5 to 15% by weight of the co-polymer, the second monomer constitutes 5 to 15% by weight of the co-polymer, with the third monomer constituting the remaining weight of the copolymer. In an example, the first monomer constitutes 8 to 12% by weight of the co-polymer, the second monomer constitutes 8 to 12% by weight of the co-polymer, with the third monomer constituting the remaining weight of the copolymer. In an example, the first monomer constitutes about 10% by weight of the co-polymer, the second monomer constitutes about 10% by weight of the co-polymer, and with the third monomer constituting the remaining weight of the copolymer. The polymer having ester side groups may be selected from the Bynel class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In an example, the polymer or polymers of the resin can be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, and Bynell 2020 (sold by E. I. du PONT)), the Aclyn family of toners (e.g. Aaclyn 201, Aclyn 246, Aclyn 285, and Aclyn 295), and the Lotader family of toners (e.g. Lotader 2210, Lotader, 3430, and Lotader 8200 (sold by Arkema)).

In some examples, the pigment constitutes a certain wt %, e.g. at least about 40 wt % of the solids of the electrostatic ink composition, and the remaining wt % of the solids of the electrostatic ink composition is formed by the resin, the charge promoting component, and, in some examples, any other additives that are present. The other additives may constitute 10 wt % or less of the solids of the electrostatic ink composition, for example 5 wt % or less, 3 wt % or less, 2 wt. % or less, 1 wt. % or less of the solids of the electrostatic ink composition.

In some examples, the resin may constitute about 10% to about 55% of the total solids in the electrostatic ink composition, for example about 10 wt. % to about 50 wt. %, about 10 wt. % to about 45 wt. %, about 10 wt. % to about 40 wt. %, about 10 wt. % to about 35 wt. %, about 10 wt. % to about 30 wt. %, about 15 wt. % to about 55 wt. %, about 15 wt. % to about 50 wt. %, about 15 wt. % to about 45 wt. %, about 15 wt. % to about 40 wt. %, about 15 wt. % to about 35 wt. %, about 15 wt. % to about 30 wt. %, about 20 wt. % to about 55 wt. %, about 20 wt. % to about 50 wt. %, about 20 wt. % to about 45 wt. %, about 20 wt. % to about 40 wt. %, about 20 wt. % to about 35 wt. %, about 20 wt. % to about 30 wt. % by total solids of the composition. The remaining wt % of the solids in the ink composition may be a pigment and a charge promoting component, and in some examples, any other additives that may be present.

In some examples, the resin may constitute up to about 55% by total solids of the electrostatic ink composition, for example up to about 50 wt. %, up to about 45 wt. %, up to about 40 wt. %, up to about 35 wt. %, or up to about 30 wt. % by total solids of the electrostatic ink composition. In some examples, the resin may constitute at least about 10 wt. %, for example at least about 15 wt. %, at least about 20 wt. % or at least about 25 wt. % of the total solids of the electrostatic ink composition.

### Pigment

The pigment can be any colorant compatible with the liquid carrier and useful for electrophotographic printing. For example, the pigment may be present as pigment particles, or may comprise a resin (in addition to the polymers described herein) and a pigment. The resins and pigments can be any of those standardly used in the art. In some examples, the pigment is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW SGT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET. In some examples, the pigment is not a conductive pigment (e.g. carbon black), i.e. in some examples the LEP ink composition does not contain a conductive pigment.

The pigment may be present in the LEP ink composition in an amount of at least about 40 wt % by total solids of the composition, for example at least about 45 wt. %, at least about 50 wt. %. In some examples, the pigment may be present in an amount of up to about 80 wt. %, for example up to about 75 wt. %, up to about 70 wt. % or up to about 65 wt. % by total solids of the composition. In some examples, the pigment is present in the LEP ink composition in an amount of about 40 wt. % to about 80 wt % of the total solids of the composition, for example about 45 wt % to about 75 wt %, about 50 wt. % to about 70 wt. % of the total solids of the composition.

In some examples, the LEP ink composition comprises a pigment and a resin as described herein in amounts such that the ratio of pigment to resin by weight is in a range of from about 1:4 to about 4:1, for example from about 2:3 to about 3:1. In some examples, the LEP ink composition comprises a pigment and a resin as described herein in amounts such that the ratio of pigment to resin by weight is at least about 1:1 (i.e. in some examples, the composition comprises a greater amount of pigment than the amount of resin by weight), for example the ratio of pigment to resin by weight may be in the range of 1:1 to 4:1, or 1:1 to 3:1.

### Charge Promoting Component

The LEP ink composition may comprise a charge promoting component comprising an aluminium C₁₂₋₂₄ carboxylate and a molecule having a molecular weight (Mw) of less than about 1000 and comprising a functional group selected from an amide, an ester, a carboxylic acid, an amine, an imide and combinations thereof.

The charge promoting component may be formed by reacting aluminium C₁₂₋₂₄ carboxylate and a molecule having a molecular weight (Mw) of less than about 1000 and comprising a functional group selected from an amide, an ester, a carboxylic acid, an amine, an imide and combinations thereof.

The term “aluminium C₁₂₋₂₄ carboxylate” is used herein to refer to an aluminium salt of a C₁₂₋₂₄ carboxylic acid. In some examples, the aluminium salt of a C₁₂₋₂₄ carboxylic acid may be an aluminium salt of a C₁₂₋₂₄ fatty acid. In some examples, the aluminium C₁₂₋₂₄ carboxylate is an aluminium C₁₆₋₁₈ carboxylate. In some examples, an aluminium C₁₆₋₁₈ carboxylate may be an aluminium stearate/palmitate, e.g. an aluminium di-/tri-stearate/palmitate. The term “aluminium stearate/palmitate” is used herein to refer to aluminium stearate, aluminium palmitate, aluminium stearate palmitate and combinations thereof.

In some examples, the aluminium C₁₂₋₂₄ carboxylate is an aluminium di- or tri-C₁₂₋₂₄ carboxylate or combinations thereof. In some examples, the aluminium C₁₂₋₂₄ carboxylate is an aluminium di- or tri-C₁₆₋₁₈ carboxylate or combinations thereof. In some examples, the aluminium stearate/palmitate is an aluminium di- or tri-stearate/palmitate or combinations thereof.

The term “aluminium stearate” is used herein to refer to an aluminium salt of stearic acid. Aluminium stearate may also be referred to as aluminum octadecanoate. In some examples the aluminium salt of stearic acid may be aluminium di-stearate or aluminium tri-stearate.

The term “aluminium palmitate” is used herein to refer to an aluminium salt of palmitic acid. Aluminium palmitate may also be referred to as aluminum hexadecanoate. In some examples the aluminium salt of palmitic acid may be aluminium di-palmitate or aluminium tri-palmitate.

In some examples, the composition comprises at least about 2 wt. % of an aluminium C₁₂₋₂₄ carboxylate, for example at least about 2.5 wt. % of an aluminium C₁₂₋₂₄ carboxylate, or at least about 3 wt. % of an aluminium C₁₂₋₂₄ carboxylate by total solids of the composition. In some examples, the composition comprises up to about 20 wt. % of an aluminium C₁₂₋₂₄ carboxylate, for example up to about 15 wt. % of an aluminium C₁₂₋₂₄ carboxylate by total solids of the composition. In some examples, the composition comprises from about 2 wt. % to about 20 wt. % of an aluminium C₁₂₋₂₄ carboxylate, for example from about 3 wt. % to about 15 wt. % of an aluminium C₁₂₋₂₄ carboxylate by total solids of the composition.

In some examples, the LEP ink composition comprises at least about 0.1 wt. % by total solids of the composition of a molecule having a molecular weight (Mw) of less than 1000 and comprising a functional group selected from an amide, an ester, a carboxylic acid, an amine (for example an imine), an imide and combinations thereof, for example at least about 0.5 wt. % by total solids of the composition. In some examples, the LEP ink composition comprises up to about 10 wt. % by total solids of the composition of a molecule having a molecular weight (Mw) of less than 1000 and comprising a functional group selected from an amide, an ester, a carboxylic acid, an amine (for example an imine), an imide and combinations thereof, for example up to about 9 wt. %, up to about 8 wt. %, up to about 7 wt. % up to about 6 wt. %, up to about 5 wt. %, or up to about 4 wt. % by total solids of the composition. In some examples, the LEP ink composition comprises from about 0.1 wt. % to about 10 wt. % by total solids of the composition of a molecule having a molecular weight (Mw) of less than 1000 and comprising a functional group selected from an amide, an ester, a carboxylic acid, an amine (for example an imine), an imide and combinations thereof, for example from about 0.5 wt. % to about 5 wt. % by total solids of the composition.

In some examples, the LEP ink composition comprises a charge promoting component comprising an aluminium C₁₂₋₂₄ carboxylate, and a molecule having a molecular weight (Mw) of less than 1000 and comprising a carboxylic acid functional group.

In some examples, the molecule having a molecular weight (Mw) of less than 1000 and comprising a functional group selected from an amide, an ester, a carboxylic acid, an amine, an imide and combinations thereof comprises, consists essentially of or consists of a polyethyleneimine, a polyisobutylene succinimide, an ester, a carboxylic acid or an amide. In some examples, the molecule having a molecular weight (Mw) of less than 1000 and comprising a functional group selected from an amide, an ester, a carboxylic acid, an amine, an imide and combinations thereof comprises, consists essentially of or consists of a molecule comprising a carboxylic acid functional group, or comprises, consists essentially of or consists of a carboxylic acid.

In some examples, the LEP ink composition comprises a charge promoting component comprising an aluminium C₁₂₋₂₄ carboxylate and a molecule having a molecular weight (Mw) of less than about 900 and comprising a functional group selected from an amide, an ester, a carboxylic acid, an amine, an imide and combinations thereof. In some examples, the LEP ink composition comprises a charge promoting component comprising an aluminium C₁₂₋₂₄ carboxylate and a molecule having a molecular weight (Mw) of less than about 800 and comprising a functional group selected from an amide, an ester, a carboxylic acid, an amine, an imide and combinations thereof. In some examples, the LEP ink composition comprises a charge promoting component comprising an aluminium C₁₂₋₂₄ carboxylate and a molecule having a molecular weight (Mw) of less than about 700 and comprising a functional group selected from an amide, an ester, a carboxylic acid, an amine, an imide and combinations thereof. In some examples, the LEP ink composition comprises a charge promoting component comprising an aluminium C₁₂₋₂₄ carboxylate and a molecule having a molecular weight (Mw) of less than about 600 and comprising a functional group selected from an amide, an ester, a carboxylic acid, an amine, an imide and combinations thereof. In some examples, the LEP ink composition comprises a charge promoting component comprising an aluminium C₁₂₋₂₄ carboxylate and a molecule having a molecular weight (Mw) of less than about 500 and comprising a functional group selected from an amide, an ester, a carboxylic acid, an amine, an imide and combinations thereof. In some examples, the LEP ink composition comprises a charge promoting component comprising an aluminium C₁₂₋₂₄ carboxylate and a molecule having a molecular weight (Mw) in the range of about 50 to about 1000 and comprising a functional group selected from an amide, an ester, a carboxylic acid, an amine, an imide and combinations thereof. In some examples, the LEP ink composition comprises a charge promoting component comprising an aluminium C₁₂₋₂₄ carboxylate and a molecule having a molecular weight (Mw) in the range of about 10 to about 1000 and comprising a functional group selected from an amide, an ester, a carboxylic acid, an amine, an imide and combinations thereof. In some examples, the LEP ink composition comprises a charge promoting component comprising an aluminium C₁₂₋₂₄ carboxylate and a molecule having a molecular weight (Mw) in the range of about 50 to about 500 and comprising a functional group selected from an amide, an ester, a carboxylic acid, an amine, an imide and combinations thereof.

In some examples the charge promoting component comprises an aluminium C₁₂₋₂₄ carboxylate and a molecule having a molecular weight (Mw) of less than about 1000 and comprising a functional group selected from an amide, an ester, a carboxylic acid, an amine, an imide and combinations thereof in a ratio of aluminium C₁₂₋₂₄ carboxylate to the molecule having a molecular weight (Mw) of less than about 1000 and comprising a functional group selected from an amide, an ester, a carboxylic acid, an amine, an imide and combinations thereof by weight of at least about 3:1, for example at least about 4:1 (i.e. in some examples, the charge promoting component comprises an aluminium C₁₂₋₂₄ carboxylate in an amount at least 3 times, for example at least 4 times, the amount of the at least four times the amount of the molecule having a molecular weight (Mw) of less than about 1000 and comprising a functional group selected from an amide, an ester, a carboxylic acid, an amine, an imide and combinations thereof).

In some examples the charge promoting component comprises an aluminium C₁₂₋₂₄ carboxylate and a molecule having a molecular weight (Mw) of less than about 1000 and comprising a functional group selected from an amide, an ester, a carboxylic acid, an amine, an imide and combinations thereof in a ratio of aluminium C₁₂₋₂₄ carboxylate to the molecule having a molecular weight (Mw) of less than about 1000 and comprising a functional group selected from an amide, an ester, a carboxylic acid, an amine, an imide and combinations thereof by weight in a range of about 4:1 to about 10:1.

The molecule having a molecular weight (Mw) of less than 1000 and comprising a functional group selected from an amide, an ester, a carboxylic acid, an amine, an imide and combinations thereof may be dissolvable in a carrier liquid described herein, for example dissolvable in a hydrocarbon carrier liquid such as an isoparaffin.

In some examples, the molecule having a molecular weight (Mw) of less than 1000 and comprising a functional group selected from an amide, an ester, a carboxylic acid, an amine (for example an imine), an imide and combinations thereof is soluble in a carrier liquid described herein (for example a hydrocarbon carrier liquid such as an isoparaffin). Such a molecule can be considered to be soluble in a carrier liquid, for example in Isopar™, when at least 20% of the molecule by total weight of the molecule and carrier liquid can be incorporated into the carrier liquid to form a mixture having a viscosity of less than 20 cps when measured using a rheometer (for example a commercially available AR-2000 Rheometer from Thermal Analysis Instruments) having 25 mmm standard steel parallel plate and determining the plate over plate rheometry isotherm at 120° C. and 0.01 hz shear rate.

In some examples, the LEP ink composition comprises a pigment and an aluminium C₁₂₋₂₄ carboxylate in a ratio of pigment to an aluminium C₁₂₋₂₄ carboxylate by weight of at least about 4:1 (i.e. in some examples, the LEP ink composition comprises a pigment in an amount at least 4 times greater than the amount of the aluminium C₁₂₋₂₄ carboxylate), in some examples at least about 5:1. In some examples, the LEP ink composition comprises an aluminium C₁₂₋₂₄ carboxylate and a pigment in a ratio of pigment to aluminium C₁₂₋₂₄ carboxylate by weight in the range of about 4:1 to about 30:1, for example about 5:1 to about 15:1.

In some examples, the LEP ink composition comprises a pigment and a charge promoting component in a ratio of pigment to charge promoting component by weight of at least about 5:1 (i.e. in some examples, the LEP ink composition comprises a pigment in an amount at least 5 times greater than the amount of the charge promoting component), in some examples at least about 6:1. In some examples, the LEP ink composition comprises a charge promoting component and a pigment in a ratio of pigment to charge promoting component by weight in the range of about 5:1 to about 30:1, for example about 5:1 to about 15:1.

### Carrier Liquid

The liquid electrostatic ink composition includes a liquid carrier. In some examples, the liquid electrostatic ink composition comprises chargeable particles including the resin which may be dispersed in the liquid carrier. The liquid carrier can include or be a hydrocarbon, silicone oil, vegetable oil, etc. The liquid carrier can include, for example, an insulating, non-polar, non-aqueous liquid that can be used as a medium for ink particles, i.e. the ink particles including the resin and, in some examples, a pigment. The liquid carrier can include compounds that have a resistivity in excess of about 10⁹ ohm·cm. The liquid carrier may have a dielectric constant below about 5, in some examples below about 3. The liquid carrier can include hydrocarbons. The hydrocarbon can include, for example, an aliphatic hydrocarbon, an isomerized aliphatic hydrocarbon, branched chain aliphatic hydrocarbons, aromatic hydrocarbons, and combinations thereof. Examples of the liquid carriers include, for example, aliphatic hydrocarbons, isoparaffinic compounds (isoparaffins), paraffinic compounds, dearomatized hydrocarbon compounds, and the like. In particular, the liquid carriers can include, for example, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

The liquid carrier can constitute about 20% to 99.5% by weight of the electrostatic ink composition, in some examples 50% to 99.5% by weight of the electrostatic ink composition. The liquid carrier may constitute about 40 to 90% by weight of the electrostatic ink composition. The liquid carrier may constitute about 60% to 80% by weight of the electrostatic ink composition. The liquid carrier may constitute about 90% to 99.5% by weight of the electrostatic ink composition, in some examples 95% to 99% by weight of the electrostatic ink composition.

The liquid electrostatic ink composition, when printed on a print substrate, may be substantially free from liquid carrier. In an electrostatic printing process and/or afterwards, the liquid carrier may be removed, e.g. by an electrophoresis processes during printing and/or evaporation, such that substantially just solids are transferred to the print substrate. Substantially free from liquid carrier may indicate that the ink printed on the print substrate contains less than 5 wt % liquid carrier, in some examples, less than 2 wt % liquid carrier, in some examples less than 1 wt % liquid carrier, in some examples less than 0.5 wt % liquid carrier. In some examples, the ink printed on the print substrate is free from liquid carrier.

### Other Additives

The liquid electrostatic ink composition may include another additive or a plurality of other additives. The other additive or plurality of other additives may be added at any stage of the method. The other additive or plurality of other additives may be selected from a wax, a surfactant, viscosity modifiers, and compatibility additives. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g. from an intermediate transfer member, which may be a heated blanket.

### Method of Producing an LEP Ink Composition

In an aspect, there is provided a method of producing a liquid electrophotographic ink composition. The method may comprise: grinding a resin and a pigment to form a paste; and forming a charge promoting component by reacting an aluminium C₁₂₋₂₄ carboxylate and a molecule having a molecular weight (Mw) of less than 1000 and comprising a functional group selected from an amide, an ester, a carboxylic acid, an amine, an imide and combinations thereof. The method may comprise combining the paste and the charge promoting component to form a liquid electrophotographic ink.

In some examples, the resin and pigment are ground in the presence of a carrier liquid as described herein to form a paste.

In some examples, the charge promoting component is mixed with a carrier liquid as described herein to form a slurry.

In some examples, the resin and pigment are ground in a ratio of pigment to resin by weight from about 1:4 to about 4:1, for example in a ratio of resin to pigment of from about 2:3 to about 3:1. In some examples, the resin and pigment are ground in a ratio of pigment to resin by weight of at least about 1:1 (i.e. in some examples the amount of pigment and resin is such that the amount of pigment used is at least equal to the amount of resin, in some examples the amount of pigment used exceeds the amount of resin used by weight), for example the ratio of pigment to resin by weight may be in the range of 1:1 to 4:1, or 1:1 to 3:1.

In some examples, the resin and pigment are ground for a time of about 6 hours to about 16 hours, for example about 10-16 hours, or about 12-16 hours, or about 12 hours.

### Method of Printing an LEP Ink Composition

In an aspect, there is provided a method of printing an LEP ink composition, the method comprising providing an LEP ink composition as described herein and liquid electrostatically printing the LEP ink composition onto a substrate.

In some examples, the method of printing an LEP ink composition may comprise printing a plurality of different LEP ink compositions to form an image on a print substrate, at least one of which comprises an LEP ink composition as described above. In some examples, the method of printing an LEP ink composition may comprise printing a cyan LEP ink composition, wherein the cyan ink composition comprises an LEP ink composition as described above. In some examples, the method of printing an LEP ink composition may comprise printing a magenta LEP ink composition, wherein the magenta ink composition comprises an LEP ink composition as described above. In some examples, the method of printing an LEP ink composition may comprise printing a yellow LEP ink composition, wherein the yellow ink composition comprises an LEP ink composition as described above. In some examples, the method of printing an LEP ink composition may comprise printing a black LEP ink composition, wherein the black ink composition comprises an LEP ink composition as described above. In some examples, the method of printing an LEP ink composition may comprise printing a cyan LEP ink composition, a magenta LEP ink composition, a yellow LEP ink composition and a black LEP ink composition, or combinations thereof, wherein at least one of the cyan, magenta, yellow and black ink compositions comprises an LEP ink composition as described above.

In some examples, liquid electrostatically printing the LEP ink composition onto a substrate may comprise contacting the LEP ink composition with a latent electrostatic image on a surface to create a developed image and transferring the developed image to a substrate, in some examples, via an intermediate transfer member.

In some examples, the surface on which the (latent) electrostatic image is formed or developed may be on a rotating member, e.g., in the form of a cylinder. The surface on which the (latent) electrostatic image is formed or developed may form a part of a photo imaging plate (PIP). The method may involve passing the LEP ink composition between a stationary electrode and a rotating member, which may be a member having the surface having the (latent) electrostatic image thereon or a member in contact with the surface having the (latent) electrostatic image thereon. A voltage is applied between the stationary electrode and the rotating member, such that particles adhere to the surface of the rotating member. The intermediate transfer member, if present, may be a rotating flexible member, which may be heated, e.g., to a temperature of from 80 to 160° C.

The substrate may be any suitable substrate. The substrate may be any suitable substrate capable of having an image printed thereon. The substrate may include a material selected from an organic or inorganic material. The material may include a natural polymeric material, e.g., cellulose. The material may include a synthetic polymeric material, e.g., a polymer formed from alkylene monomers, including, for example, polyethylene and polypropylene, and co-polymers such as styrene-polybutadiene. The polypropylene may, in some examples, be biaxially orientated polypropylene. The material may include a metal, which may be in sheet form. The metal may be selected from or made from, for instance, aluminium (Al), silver (Ag), tin (Sn), copper (Cu), mixtures thereof. In an example, the substrate includes a cellulosic paper. In an example, the cellulosic paper is coated with a polymeric material, e.g., a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The substrate is, in some examples, a cellulosic print substrate such as paper. The cellulosic print substrate is, in some examples, a coated cellulosic print. In some examples, a primer may be coated onto the print substrate, before the liquid electrostatic ink composition is printed onto the print substrate.

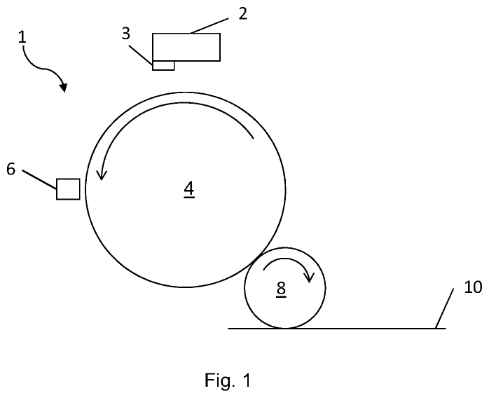

FIG. 1 shows a schematic illustration of a liquid electrophotographic (LEP) printing apparatus which may be used to liquid electrostatically print a liquid electrophotographic ink composition as described herein. An image, including any combination of graphics, text and images, may be communicated to the LEP printing apparatus 1. According to an illustrative example, in order to print the LEP ink composition, firstly, the photo charging unit 2 deposits a uniform static charge on the photo-imaging cylinder 4 and then a laser imaging portion 3 of the photo charging unit 2 dissipates the static charges in selected portions of the image area on the photo-imaging cylinder 4 to leave a latent electrostatic image. The latent electrostatic image is an electrostatic charge pattern representing the image to be printed. The liquid electrophotographic ink composition is then transferred to the photo-imaging cylinder 4 by Binary Ink Developer (BID) unit 6. The BID unit 6 presents a uniform film of the liquid electrophotographic ink composition to the photo-imaging cylinder 4. The ink particles of the liquid electrophotographic ink composition may be electrically charged by virtue of an appropriate potential applied to the liquid electrophotographic ink composition in the BID unit. The charged ink particles are attracted, by virtue of an appropriate potential on the electrostatic image areas, to the latent electrostatic image on the photo-imaging cylinder 4. The electrophotographic ink composition does not adhere to the uncharged, non-image areas and forms a developed image on the surface of the latent electrostatic image. The photo-imaging cylinder 4 then has a developed electrophotographic ink composition image on its surface.

The developed image is then transferred from the photo-imaging cylinder 4 to the intermediate transfer member (ITM) 8 by virtue of an appropriate potential applied between the photo-imaging cylinder 4 and the ITM 8, such that the charged electrophotographic ink composition is attracted to the ITM 8. The developed image is then dried and fused on the ITM 8 before being transferred to a substrate 10.

Between the transfer of the developed image onto the ITM and the transfer of the developed image to the substrate from the ITM the solid content of the electrophotographic ink composition image is increased and the electrophotographic ink composition is fused on to the ITM 8. For example, the solid content of the electrophotographic ink composition image deposited on the ITM 8 is typically around 20%, whereas when the image is transferred to the substrate from the ITM the solid content of the image is typically around 80-90%. This drying and fusing is typically achieved by using elevated temperatures and air flow assisted drying. In some examples, the ITM 8 is heatable.

The present disclosure also provides a substrate having printed thereon an LEP ink composition as described herein and/or producible according to the method described herein.

### EXAMPLES

The following illustrates examples of the compositions and related aspects described herein. Thus, these examples should not be considered to restrict the present disclosure, but are merely in place to teach how to make examples of compositions of the present disclosure.

### Example 1—Preparation of a LEP Ink Composition

276 g of a cyan pigment (Heliogen™ D 7086, obtained from BASF™, this pigment has not been surface treated) was ground with 460 g Resin paste (the resin paste containing 40 wt. % AC5120™ resin (an ethylene acrylic acid copolymer obtained from Honeywell™) and 60 wt. % of Isopar™ L (obtained from ExxonMobil™) in an S1 attritor for 12 hours at temperature of 45° C., a speed of 250 rpm. The ground resin paste was than diluted with additional carrier liquid (Isopar™ L) to 3% NVS (non-volatile solids) to create a dispersion.

A charge promoting component (referred to in table 1 below as “VCA-J560”) was then provided by grinding 340 g of an aluminum C₁₂₋₂₄ carboxylate (VCA, available from sigma Aldrich, VCA contains aluminum stearate/palmitate) with 68 g of molecule having a molecular weight (Mw) of less than about 1000 and comprising a functional group selected from an amide, an ester, a carboxylic acid, an amine, an imide and combinations thereof (Solsperse™ J560, a polyisobutylene succinimide available from Lubrizol™) in an S1 attritor for 12 hours at temperature of 45° C., a speed of 250 rpm. Isopar™ L was added to the charge promoting component to produce a slurry containing 0.5 wt % of the charge promoting component by total weight of the slurry.

The slurry containing the charge promoting component was then mixed with the pigment and resin containing dispersion to produce a cyan LEP ink composition having the formulation provided in table 1 below.

TABLE 1

| Component of LEP ink | |
|---|---|
| composition of Example 1 | Wt. % by total solids |
| Cyan pigment (Heliogen D | 52.3 |
| 7086) | |
| Resin (AC5120 resin) | 34.8 |
| Charge promoting | 12.9 (10.75 wt % VCA; |
| component (VCA-J560) | 2.15 wt. % J560) |

### Examples 2-4

Further cyan LEP ink compositions of Examples 2-4 were prepared in the same way as the cyan LEP ink composition of Example 1 except that different cyan pigments (Heliogen™ D 7079 (available from BASF™); Lionol™ Blue FG 7351 (available from Toyo™); and Lionol™ Blue SL (available from Toyo™), respectively) were employed. Heliogen™ D 7079 is a cyan pigment which has been surface treated such that it contains an acidic rosin, Lionol™ Blue FG 7351 has not been surface treated, Lionol™ Blue SL has been surface treated with a neutral rosin.

### Example 5

A yellow LEP ink composition was produced in the same way as the cyan LEP ink composition of Example 1, except that a yellow pigment was used (Permanent Yellow GR) and the charge promoting component was added in a slurry containing 0.2 wt % charge promoting component by total weight of slurry. The formulation of the yellow LEP ink composition of Example 5 is provided in table 2 below.

### Example 6

A magenta LEP ink composition was produced in the same way as the cyan LEP ink composition of Example 1, except that a magenta pigment (QUINDO® MAGENTA) was used and the charge promoting component was added in a slurry containing 0.7 wt % charge promoting component by total weight of slurry. The formulation of the magenta LEP ink composition of Example 6 is provided in table 2 below.

### Example 7

A black LEP ink composition was produced in the same way as the cyan LEP ink composition of Example 1, except that a black pigment was used (the black pigment employed contained a mixture of the cyan, yellow and magenta pigments described above) and the charge promoting component was added in a slurry containing 0.3 wt % charge promoting component by total weight of slurry. The formulation of the black LEP ink composition of Example 7 is provided in table 2 below.

TABLE 2

| | | | Charge promoting |
|---|---|---|---|
| | Pigment (wt. % | Resin (wt. % | component (wt. % |
| Composition | by total solids) | by total solids) | by total solids) |
| Example 5 | 56.6 | 37.8 | 5.6 (4.7 wt. % VCA; |
| | (yellow) | | 0.9 wt. % J560) |
| Example 6 | 49.7 | 33.1 | 17.2 (14.3 wt. % VCA; |
| | (magenta) | | 2.9 wt. % J560) |
| Example 7 | 55.1 | 36.7 | 8.2 (6.8 wt. % VCA; |
| | (black) | | 1.4 wt. % J560) |

### Examples 8-11

Cyan, yellow, magenta and black LEP ink compositions were prepared according to Examples 1 and 5-7 respectively, except that the pigment-resin dispersion was provided at 4% NVS (non-volatile solids). The formulations of the LEP ink compositions of Examples 8-11 are provided in table 3 below.

TABLE 3

| | | | Charge promoting |
|---|---|---|---|
| | Pigment (wt. % | Resin (wt. % | component (wt. % |
| Composition | by total solids) | by total solids) | by total solids) |
| Example 8 | 59.3 | 29.7 | 11.0 (9.2 wt. % VCA; |
| | (cyan) | | 1.8 wt. % J560) |
| Example 9 | 63.5 | 31.8 | 4.7 (3.9 wt. % VCA; |
| | (yellow) | | 0.8 wt. % J560) |
| Example 10 | 56.9 | 28.4 | 14.7 (12.25 wt. % VCA; |
| | (magenta) | | 2.45 wt. % J560) |
| Example 11 | 62.1 | 31.0 | 6.9 (5.75 wt. % VCA; |
| | (black) | | 1.15 wt. % J560) |

The compositions of Examples 1-11 were used to print images onto paper using a liquid electrophotographic printing press (HP Indigo 6xxx) in one-shot printing mode. All of the compositions described above produced images. Therefore, the present inventors have demonstrated that LEP ink compositions described herein exhibit good charging such that they are able to produce images in a liquid electrostatic printing process, the images showing good optical density.

The present inventors have also produced liquid electrophotographic ink compositions having similar compositions to those described above where the charge promoting component was formed by grinding an aluminium C₁₂₋₂₄ carbon/late (VCA from Sigma Aldrich was used) with the following molecules in place of Solsperse™ J560: Solsperse™ J561 (a polyisobutylene succinimide obtained from Lubrizol™); Solsperse™ P6000 (a molecule containing ester, amide amine and imine functional groups obtained from Lubrizol™); Solsperse™ 13300 (a molecule containing ester, amide amine and imine functional groups obtained from Lubrizol™); Solsperse™ 3000 (an ester from Lubrizol); Solsperse™ 21000 (an ester from Lubrizol); Dymerex™ polymerized rosin (a carboxylic acid containing molecule). It was found that each of these compositions were also printable liquid electrostatically to provide images with good optical density.

The present inventors have also found that the compositions described herein can be liquid electrostatically printed without requiring the addition of a charge director (e.g. NCD or SCD) before printing.

The present inventors have also found that the compositions described herein can be produced more efficiently than previous compositions due to requiring a shorter pigment and resin grinding time than conventional compositions.

While the methods, compositions and related aspects have been described with reference to certain examples, it will be appreciated that various modifications, changes, omissions, and substitutions can be made without departing from the spirit of the disclosure. It is intended, therefore, that the methods and related aspects be limited only by the scope of the following claims. Unless otherwise stated, the features of any dependent claim can be combined with the features of any of the other dependent claims, and any other independent claim.

1. A method for producing a liquid electrophotographic ink composition, the method comprising:
grinding a resin and a pigment to form a paste;
reacting an aluminium C₁₂₋₂₄ carboxylate and a molecule having a molecular weight (Mw) of less than about 1000 and comprising a functional group selected from an amide, an ester, a carboxylic acid, an amine, an imide and combinations thereof to form a charge promoting component; and
combining the paste and the charge promoting component to form a liquid electrophotographic ink.

2. A method according to claim 1, comprising grinding the aluminium C₁₂₋₂₄ carboxylate and the molecule having a molecular weight (Mw) of less than about 1000 and comprising a functional group selected from an amide, an ester, a carboxylic acid, an amine, an imide and combinations thereof to form a charge promoting component.

3. A method according to claim 1, wherein the resin and pigment are ground in a ratio of pigment to resin from about 1:1 to about 4:1.

4. A method according to claim 1, wherein the aluminium C₁₂₋₂₄ carboxylate and the molecule having a molecular weight (Mw) of less than about 1000 and comprising a functional group selected from an amide, an ester, a carboxylic acid, an amine, an imide and combinations thereof are reacted in a ratio of aluminium C₁₂₋₂₄ carboxylate to the molecule having a molecular weight (Mw) of less than about 1000 and comprising a functional group selected from an amide, an ester, a carboxylic acid, an amine, an imide and combinations thereof by weight in a range of about 4:1 to about 10:1.

5. A method according to claim 1, wherein the LEP ink composition formed comprises a pigment and an aluminium C₁₂₋₂₄ carboxylate in a ratio of pigment to aluminium C₁₂₋₂₄ carboxylate by weight of at least about 4:1.

6. A method according to claim 1, wherein the resin, pigment, aluminium C₁₂₋₂₄ carboxylate and molecule having a molecular weight (Mw) of less than 1000 and comprising a functional group selected from an amide, an ester, a carboxylic acid, an amine, an imide and combinations thereof, are provided in amounts such that the liquid electrophotographic ink compositions comprises:
at least about 40 wt. % of the pigment by total solids of the composition;
from about 10 wt. % to about 55 wt. % of the resin by total solids of the composition;
from about 2 wt. % to about 20 wt. % of the aluminium C₁₂₋₂₄ carboxylate by total solids of the composition; and
from about 0.1 wt. % to about 10 wt. % by total solids of the composition of the molecule having a molecular weight (Mw) of less than about 1000 and comprising a functional group selected from an amide, an ester, a carboxylic acid, an amine, an imide and combinations thereof.

7. A liquid electrophotographic ink composition comprising:
at least about 40 wt. % of a pigment by total solids of the composition;
from about 10 wt. % to about 55 wt. % of a resin by total solids of the composition;
from about 2 wt. % to about 20 wt. % of an aluminium C₁₂₋₂₄ carboxylate by total solids of the composition; and
from about 0.1 wt. % to about 10 wt. % by total solids of the composition of a molecule having a molecular weight (Mw) of less than about 1000 and comprising a functional group selected from an amide, an ester, a carboxylic acid, an amine, an imide and combinations thereof.

8. A liquid electrophotographic ink composition according to claim 7, wherein the resin comprises a polymer having acid side groups.

9. A liquid electrophotographic ink composition according to claim 7, wherein the aluminium C₁₂₋₂₄ carboxylate is an aluminium di-/tri-stearate/palmitate.

10. A liquid electrophotographic ink composition according to claim 7 comprising less than about 40 wt. % of the resin by total solids of the composition.

11. A liquid electrophotographic ink composition according to claim 7 comprising from about 0.5 wt. % to about 5 wt. % by total solids of the composition of a molecule having a molecular weight (Mw) of less than about 1000 and comprising a functional group selected from an amide, an ester, a carboxylic acid, an amine, an imide and combinations thereof.

12. A liquid electrophotographic ink composition according to claim 7 comprising from about 3 wt. % to about 15 wt. % of an aluminium C₁₂₋₂₄ carboxylate by total solids of the composition.

13. A liquid electrophotographic ink composition according to claim 7 further comprising a carrier liquid, wherein the molecule having a molecular weight (Mw) of less than 1000 and comprising a functional group selected from an amide, an ester, a carboxylic acid, an amine, an imide and combinations thereof is dissolvable in the carrier liquid.

14. A liquid electrophotographic ink composition according to claim 7, wherein the composition comprises a greater amount of the pigment than the amount of resin by weight.

15. A method of printing a liquid electrophotographic ink composition, the method comprising:
providing a liquid electrophotographic ink composition; and
liquid electrostatically printing the liquid electrostatic ink composition onto a substrate, wherein the liquid electrophotographic ink composition comprises:
at least about 40 wt. % of a pigment by total solids of the composition;
from about 10 to about 55 wt. % of a resin by total solids of the composition;
from about 2 to about 20 wt. % of an aluminium C₁₂₋₂₄ carboxylate by total solids of the composition; and
from about 0.1 to about 10 wt. % by total solids of the composition of a molecule having a molecular weight (Mw) of less than about 1000 and comprising a functional group selected from an amide, an ester, a carboxylic acid, an amine, an imide and combinations thereof.
